(19) United States
(12) Patent Application Publication
(10) Pub. No.: US 2005/0108593 A1
(43) Pub. Date: May 19, 2005

(54) Cluster failover from physical node to virtual node

(75) Inventors: Ranjith Purushothaman, Austin, TX (US); Peyman Najafirad, Austin, TX (US)

Correspondence Address: BAKER BOTTS, LLP, 910 LOUISIANA, HOUSTON, TX, 77002-4995, US

(73) Assignee: Dell Products L.P.

(21) Appl. No.: 10/713,379

(22) Filed: Nov. 14, 2003

(51) Int. Cl. G06F 11/00; G06F 15/177

(52) U.S. Cl. 714/4; 709/221

(57) ABSTRACT

The present invention provides a system, method and apparatus for facilitating the failover of a cluster process from a physical node to a virtual node so that interrupts of the affected software application are minimized. Upon detection that a node on the cluster has failed, a signal is sent to the failover or the backup server to start a virtual machine (virtual node) that can accommodate the failed process. The failed process is then resumed on the virtual node until the failed node is rebooted, repaired, or replaced. Once the failed node is made operational, the process that is running on the virtual node is transferred back to the newly operational node.

### BACKGROUND OF THE INVENTION TECHNOLOGY

1. Field of the Invention

The present invention is related to information handling systems, and more specifically, to a system and method for providing backup server service in a multi-computer environment in the event of failure of one of the computers.

2. Description of the Related Art

As the value and the use of information continue to increase, individuals and businesses seek additional ways to process and store information. One option available to users is information handling systems. An information handling system generally processes, compiles, stores and/or communicates information or data for business, personal or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, redundant array of independent disks (“RAID”) system and telecommunications switch.

A cluster is a parallel or distributed system that comprises a collection of interconnected computer systems or servers that is used as a single, unified computing unit. Members of a cluster are referred to as nodes or systems. The cluster service is the collection of software on each node that manages cluster-related activity. The cluster service sees all resources as identical objects. Resource may include physical hardware devices, such as disk drives and network cards, or logical items, such as logical disk volumes, TCP/IP addresses, entire applications and databases, among other examples. A group is a collection of resources to be managed as a single unit. Generally, a group contains all of the components that are necessary for running a specific application and allowing a user to connect to the service provided by the application. Operations performed on a group typically affect all resources contained within that group. By coupling two or more servers together, clustering increases the system availability, performance, and capacity for network systems and applications.

Clustering may be used for parallel processing or parallel computing to use two or more CPUs simultaneously to execute an application or program. Clustering is a popular strategy for implementing parallel processing applications because it allows system administrators to leverage already existing computers and workstations. Because it is difficult to predict the number of requests that will be issued to a networked server, clustering is also useful for load balancing to distribute processing and communications activity evenly across a network system so that no single server is overwhelmed. If one server is running the risk of being swamped, requests may be forwarded to another clustered server with greater capacity. For example, busy Web sites may employ two or more clustered Web servers in order to employ a load balancing scheme. Clustering also provides for increased scalability by allowing new components to be added as the system load increases. In addition, clustering simplifies the management of groups of systems and their applications by allowing the system administrator to manage an entire group as a single system. Clustering may also be used to increase the fault tolerance of a network system. If one server suffers an unexpected software or hardware failure, another clustered server may assume the operations of the failed server. Thus, if any hardware of software component in the system fails, the user might experience a performance penalty, but will not lose access to the service.

Current cluster services include Microsoft CLUSTER SERVER™ (“MSCS”), designed by Microsoft Corporation of Redmond, Wash., for clustering for its WINDOWS NT® 4.0 and WINDOWS 2000 ADVANCED SERVER® operating systems, and NOVELL NETWARE CLUSTER SERVICES™ (“NWCS”), the latter of which is available from Novell in Provo, Utah, among other examples. For instance, MSCS currently supports the clustering of two NT servers to provide a single highly available server. Generally, Windows NT clusters are “shared nothing” clusters. While several systems in the cluster may have access to a given device or resource, it is effectively owned and managed by a single system at a time. Services in a Windows NT cluster are presented to the user as virtual servers. From the user's standpoint, the user is connecting to an actual physical system. In fact, the user is connecting to a service which may be provided by one of several systems. Users create TCP/IP session with a service in the cluster using a known IP address. This address appears to the cluster software as a resource in the same group as the application providing the service.

In order to detect system failures, clustered servers may use a heartbeat mechanism to monitor the health of each other. A heartbeat is a periodic signal that is sent by one clustered server to another clustered server. A heartbeat link is typically maintained over a fast Ethernet connection, private local area network (“LAN”) or similar network. A system failure is detected when a clustered server is unable to respond to a heartbeat sent by another server. In the event of failure, the cluster service will transfer the entire resource group to another system. Typically, the client application will detect a failure in the session and reconnect in the same manner as the original connection. The IP address is now available on another machine and the connection will be re-established. For example, if two clustered servers that share external storage are connected by a heartbeat link and one of the servers fails, then the other server will assume the failed server's storage, resume network services, take IP addresses, and restart any registered applications.

High availability clusters provide the highest level of availability by the use of cluster “failover,” in which applications and/or resources can move automatically between two or more nodes within the system in the event of a failure of one or more of the nodes. The main purpose of the failover cluster is to provide uninterrupted service in the event of a failure within the cluster. However, most failover technologies implement failover by moving applications from the failed node to another node that is already running another application, thereby impacting the performance of the other application. Moreover, moving applications is not a viable option when multiple applications cannot co-exist on a single node due to security or compatibility reasons.

In the prior art, certain failover options, such as N+1, Multiway, Cascading, and N-way failovers are usable for high availability clustering solutions. However, all of the aforementioned failover options (except for N+1) assume that the applications that were running originally on separate nodes can co-exist on a single node when failover occurs without any security or compatibility issues. The N+1 failover option dedicates a single node for failover only—the single node does not run any applications. The N+1 option also provides the best solution for critical applications since a single node is dedicated for failover. However, if more than one node fails, all failovers are directed to the single dedicated failover node, and a single cluster node may lack the resources to support multiple cluster node failures. Moreover, additional problems can occur if the failed node was running multiple applications.

There is, therefor, a need in the art for a failover mechanism that minimizes performance degradation, doesn't overload a single (failover) node, and enables the segregation of multiple applications for compatibility and/or security reasons.

### SUMMARY OF THE INVENTION

The present invention remedies the shortcomings of the prior art by providing a method, system and apparatus, in an information handling system, for managing one or more physical cluster nodes with a distributed cluster manager, and providing a failover physical server, and a backup physical server for failover redundancy.

In a scenario where the different nodes within the cluster are running applications that are incompatible with one another, the only viable failover option is the N+1 failover mechanism. However, if more than one physical node fails, N+1 mechanism cannot host the applications from the multiple servers since the applications are incompatible. While an N+N failover mechanism is the ideal solution in such a scenario, the N+N mechanism is very expensive and not a viable option for economic reasons. The present invention provides a viable solution for this latter scenario. The technique of the present invention is called the N+m failover, where N is the number of physical nodes, and m is equal to the number of virtual machines (virtual nodes). The number of virtual machines is based on the load and the type of applications in the cluster environment. The virtual machines are dedicated for failover only and they may be hosted on a single or multiple physical servers, depending on the load of the cluster.

The use of virtual nodes for failover purposes preserves the segregation of applications for compatibility and security reasons. Moreover, the failover virtual nodes can be distributed among several physical nodes so that any particular node is not overly impacted if multiple failures occur. Finally, the failover technique of the present invention can be combined with other failover techniques, such as N+1, so that the failover can be directed to virtual failover nodes on the backup server to further enhance failover redundancy and capacity. The present invention, therefore, is ideal for mission critical applications that cannot be run simultaneously on a single node.

The present invention includes a method of failover that will failover the processes from the physical node to a virtual node when a physical node fails. The processes of the failed physical node will then be resumed on the virtual node until the failed physical node is repaired and available, or another physical node is added to the cluster.

The present invention includes a method of failover in a cluster having one or more cluster nodes. A second server, such as a failover server, that is operative with the cluster is provided. When a failed process on one of the cluster nodes is detected, the failed process is duplicated on a virtual node on the second server and the process is resumed on the virtual node.

The present invention also provides a system comprising a cluster. The cluster can be composed of one or more cluster nodes, with each of the cluster nodes being constructed and arranged to execute at least one process. Finally, a second (failover) server is provided. The second server is operative with the cluster. The second server has one or more virtual nodes, and each of the virtual nodes is constructed and arranged to execute the process of the cluster node. If one or more of said cluster nodes fails, then each of the processes of the failed cluster nodes are transferred to a virtual nodes on the second server. In another embodiment, a single virtual node can accommodate multiple processes for those situations where process segregation is not necessary.

The present invention also provides a system comprising a cluster. The cluster is composed of one or more cluster nodes, with each of the cluster nodes being constructed and arranged to execute one or more processes. A distributed cluster manager is provided that is operative with each of said cluster nodes. The distributed cluster manager is constructed and arranged to detect one or more failures of one or more processes on any of the cluster nodes. Finally, the system is provided with a second (failover) server. The second server is operative with the distributed cluster manager. The second server has a dynamic virtual failover layer that is operative with the distributed cluster manager. In addition, the second server has one or more virtual nodes that are operative with the dynamic virtual failover layer. Each of the virtual nodes of the second server is constructed and arranged to execute said one or more processes of the cluster nodes. If one or more of the cluster nodes fails, then one or more processes of the failed cluster node are transferred to one or more of the virtual nodes of the second server. A third (or more) servers can also be added to the system preferably having the same capabilities as the second server. When two additional servers are operative with the cluster, one of the servers can be the failover server, and the other one the backup server. As mentioned before, additional servers may be added to the cluster to provide additional virtual machines (nodes) to further enhance the robustness and availability of the processes of the system.

The system of the present invention can be implemented on one or more computers having at least one microprocessor and memory that is capable of executing one or more processes. Both the cluster nodes and the additional servers can be implemented in hardware, in software, or in some combination of hardware and software.

Other technical advantages of the present disclosure will be readily apparent to one skilled in the art from the following figures, descriptions and claims. Various embodiments of the invention obtain only a subset of the advantages set forth. No one advantage is critical to the invention.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a block diagram of an information handling system according to the teachings of the present invention.

FIG. 2 is a block diagram of a first embodiment of the failover mechanism according to the teachings of the present invention.

FIG. 3 is a block diagram of an alternate embodiment of the failover mechanism according to the teachings of the present invention.

FIG. 4 is a flowchart illustrating an embodiment of the method of the present invention.

The present invention may be susceptible to various modifications and alternative forms. Specific exemplary embodiments thereof are shown by way of example in the drawing and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

The invention proposes to solve the problem in the prior art by employing a system, apparatus and method that utilizes virtual machines operating on one or more servers to take over the execution of one or more processes on the failed nodes so that those processes can be resumed as quickly as possible. Moreover, the use of virtual machines (acting virtual servers or virtual nodes) can be used to segregate applications for security or privacy reasons, and to balance the loading between backup infrastructure, such as the failover servers and the backup servers.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (“RAM”), one or more processing resources such as a central processing unit (“CPU”), hardware or software control logic, ROM, and/or other types of nonvolatile memory. Additional components of the information handling system may include one or more disk drives, one or more network ports for communicating with external devices, as well as various input and output (“I/O”) devices, such as a keyboard, a mouse, and a video display. The information handling system may also include one or more buses operable to transmit communications among the various hardware components.

Referring now to the drawings, the details of an exemplary embodiment of the present invention are schematically illustrated. Like elements in the drawings will be represented by like numbers, and similar elements will be represented by like numbers with a different lower case letter suffix.

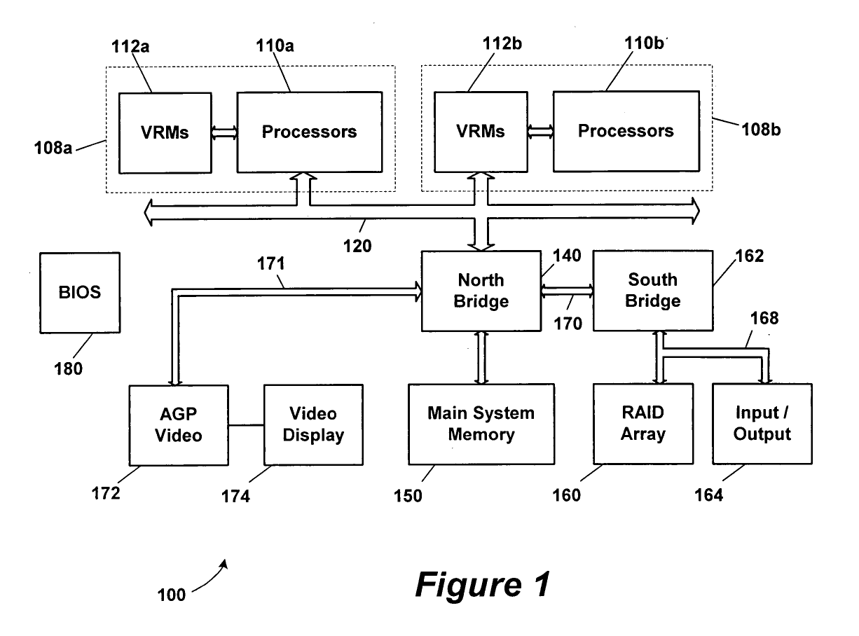

Referring to FIG. 1, depicted is an information handling system having electronic components mounted on at least one printed circuit board (“PCB”) (not shown) and communicating data and control signals therebetween over signal buses. In one embodiment, the information handling system is a computer system. The information handling system, generally referenced by the numeral 100, comprises processors 110 and associated voltage regulator modules (“VRMs”) 112 configured as processor nodes 108. There may be one or more processor nodes 108 (two nodes 108a and 108b are illustrated). A north bridge 140, which may also be referred to as a “memory controller hub” or a “memory controller,” is coupled to a main system memory 150. The north bridge 140 is coupled to the processors 110 via the host bus 120. The north bridge 140 is generally considered an application specific chip set that provides connectivity to various buses, and integrates other system functions such as memory interface. For example, an INTEL® 820E and/or 815E chip set, available from the Intel Corporation of Santa Clara, Calif., provides at least a portion of the north bridge 140. The chip set may also be packaged as an application specific integrated circuit (“ASIC”). The north bridge 140 typically includes functionality to couple the main system memory 150 to other devices within the information handling system 100. Thus, memory controller functions such as main memory control functions typically reside in the north bridge 140. In addition, the north bridge 140 provides bus control to handle transfers between the host bus 120 and a second bus(es), e.g., PCI bus 170 and AGP bus 171, the AGP bus 171 being coupled to the AGP video 172 and/or the video display 174. The second bus may also comprise other industry standard buses or proprietary buses, e.g., ISA, SCSI, USB buses 168 through a south bridge (bus interface) 162. These secondary buses 168 may have their own interfaces and controllers, e.g., RAID storage system 160 and input/output interface(s) 164. Finally, a BIOS 180 is operative with the information handling system 100 as illustrated in FIG. 1. The information handling system 100 can be combined with other like systems to form larger systems. Moreover, the information handling system 100 can be combined with other elements, such as networking elements, to form even larger and more complex information handling systems.

When the cluster manager detects a failed cluster node, or a failed application within the cluster node, the cluster manager moves all of the processes from the affected cluster node to a virtual node and remaps the virtual server to a new network connection. The network client attached to an application in the failed physical node will experience only a momentary delay in accessing their resources while the cluster manager reestablishes a network connection to the virtual server. The process of moving and restarting a virtual server on a healthy cluster node is called failover.

In a standard client/server environment, a user accesses a network resource by connecting to a physical server with a unique Internet Protocol (“IP”) address and network name. If the server fails for any reason, the user will no longer be able to access the resource. In a cluster environment according to the present invention, the user does not access a physical server. Instead, the user accesses a virtual server—a network resource that is managed by the cluster manager. The virtual server is not associated with a physical server. The cluster manager manages the virtual server as a resource group, which contains a list of the cluster resources. Virtual servers and resource groups are, thus, transparent to the network client and user.

The virtual servers of the present invention are designed to reconfigure user resources dynamically during a connection failure or a hardware failure, thereby providing a higher availability of network resources as compared to a nonclustered systems. When the cluster manager detects a failed cluster node or a failed software application, the cluster manager moves the entire virtual server resource group to another cluster node and remaps the virtual server to the new network connection. The network client attached to an application in the virtual server will only experience a momentary delay in accessing their resources while the cluster manager reestablishes a network connection to the virtual server. This process of moving and restarting a virtual server on a healthy cluster node is called failover.

Virtual servers are designed to reconfigure user resources dynamically during a connection failure or a hardware failure, providing a higher availability of network resources as compared to a non-clustered systems. If one of the cluster nodes should fail for any reason, the cluster manager moves (or fails over) the virtual server to another cluster node. After the cluster node is repaired and brought online, the cluster manager moves (or fails back) the virtual server to the original cluster node, if required. This failover capability enables the cluster configuration to keep network resources and application programs running on the network while the failed node is taken off-line, repaired, and brought back online. The overall impact of a node failure to network operation is minimal.

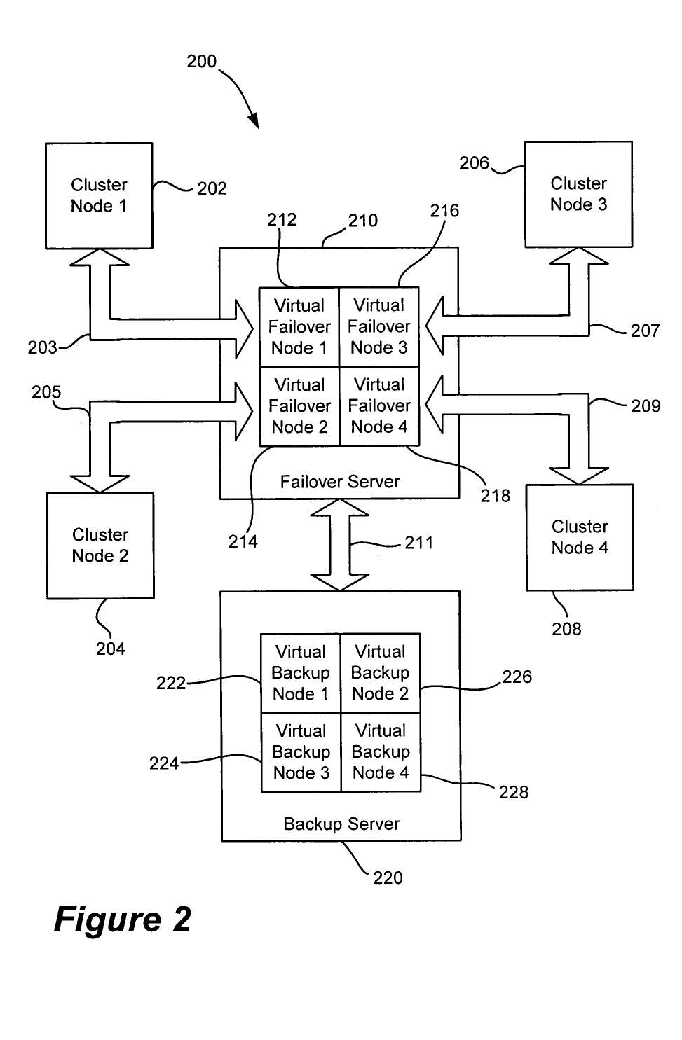

A first embodiment of the present invention is illustrated in FIG. 2. The system 200 has four nodes in the cluster, specifically nodes 202, 204, 206, and 208. While four nodes are shown, it will be understood that clusters of greater and lesser nodes can be used with the present invention. In addition to the nodes 202-208, which in this example are physical nodes, there is also a failover server 210 and a backup server 220, as illustrated in FIG. 2. The failover server 210 is equipped with four virtual failover nodes 212, 214, 216, and 218 that correspond to cluster nodes 202, 204, 206, and 208, respectively, through data channels 203, 205, 207, and 209, respectively. While multiple data channels are shown in this embodiment, it will be understood that a single data channel (akin to a data bus) could be used to convey the failover and service the data communication traffic. The backup server 220 is operative with the failover server 210 via data channel 211 as illustrated in FIG. 2. As with the failover server, the backup server 220 has as many virtual backup nodes (222-228) as there are cluster nodes (202-208). In one sub-embodiment of the system 200, if a cluster node, such as cluster node 202, fails, virtual failover node 212 is activated via data channel 203 and takes over processing. If virtual failover node 212 fails, its processing is taken over by virtual backup node 222 via data channel 211. In this way, there is a clear failover path for each cluster node. Alternatively, however, failovers can be handled sequentially. For example, if cluster node 208 fails first, its processing can be taken over by the virtual failover node 212. If cluster node 202 fails second, then its processing would be taken over by virtual failover node 214. In the scenario where multiple cluster nodes have failed, and the failover server 210 is handling multiple processes simultaneously, one or more of the applications being handled by the failover server 210 can be transferred intentionally to the backup server 220. For example, the processing that was originally on cluster node 208 (which is now being handled by virtual failover node 212, could be allowed to continue running on the failover server 210, and the second failed node's processing could be transferred from the second virtual failover node 214 to the first virtual backup node 222. The latter scenario is useful for balancing the load between the failover server 210 and the backup server 220, thereby maintaining the overall performance of the system 200.

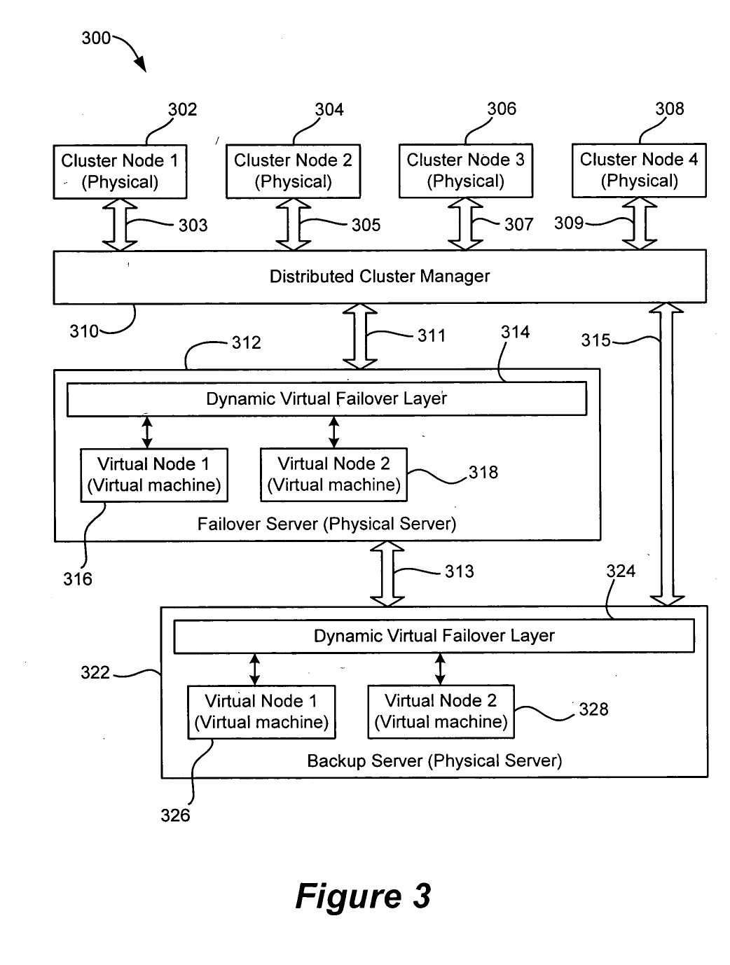

FIG. 3 illustrates a second embodiment of the present invention. The system 300 has multiple cluster nodes 302, 304, 306, and 308 that are constructed and arranged to communicate with a distributed cluster manager 310 through messages 303, 305, 307, and 309, respectively. The distributed cluster manager 310 can communicate through messages 311 and 315 to the failover server 312 and to the backup server 322, respectively, as illustrated in FIG. 3. Further, the failover server 312 can communicate with the backup server 322 through messages 313. The failover server 312 is equipped with a dynamic virtual failover layer 314 that receives the messages 311 from the distributed cluster manager 310. The dynamic virtual failover layer 314 governs the activities of the multiple virtual nodes 316, 318 and others (not shown) of the failover server 314. While two virtual nodes are shown in the failover server 312, it will be understood that one or more virtual nodes (virtual machines) may be implemented on the failover server 312.

As with the failover server 312, the backup server 322 has its own dynamic virtual failover layer 324 that governs the activities of the one or more virtual nodes 326, 328 and others (not shown). As with the case of the failover server 312, the virtual nodes of the backup server can be implemented as virtual machines that mimic the operating system and the physical server of the process that is (was) running on the cluster node that failed. A useful feature of this embodiment of the present invention is that the distributed cluster manager 310 can detect the failure of the particular cluster node and, knowing the relative loading of the failover server 312 and the backup server 322, can delegate the failed node's activities to the dynamic virtual failover layer of the selected failover/backup server quickly, depending upon the relative loading of the failover/backup servers. Once the dynamic virtual failover layer receives the message to take over from a failed cluster node, a virtual machine within the respective failover or backup server can be activated with the operating system and physical attributes (such as peripherals and central processing unit) of the failed cluster node. Once activated, the virtual machine begins to execute the processes of the failed cluster node.

In each embodiment of the present invention, once the failed cluster node is repaired or otherwise made operational, the processes handled by the virtual failover node, virtual backup node, or virtual node can be moved back to the cluster node in question and resumed.

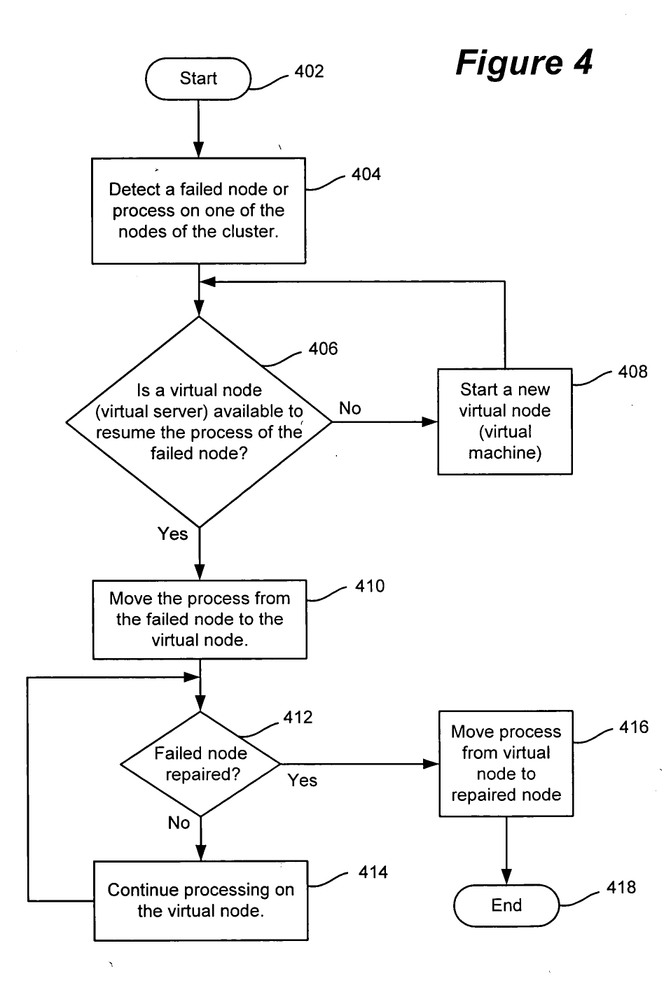

FIG. 4 illustrates an embodiment of the method of the present invention. The method 400 begins generally at step 402. In step 404, a failed node is detected. The method of detection can vary for the systems 100, 200, or 300. For example, a heartbeat mechanism can be employed, or an external device can determine that no activity has emanated from the node in question for a given period of time, or the distributed cluster manager 310 can determine if the node has become inoperative. Other detection mechanisms may also be employed with the systems described herein. In any case, once the failed node has been detected, step 406 is performed, where a check is made to determine if a virtual node is available to take over processing of the application (or applications) that were being handled by the failed node. Note, the available virtual node may be on the failover server 312 or, in case the failover server 312 has itself failed, then a virtual node on the backup server 322 is used. If no virtual node (virtual machine or virtual server) is available, then step 408 is executed to start a new virtual node on, for example, the failover server 312 or the backup server 322 as described above. If a virtual node is available or otherwise made available, the step 410 is performed, wherein the process or processes of the failed node are moved (or duplicated) to the virtual node and resumed.

While the virtual node is operating, periodic (or directed) checks are made in step 412 to determine whether or not the failed node has been rebooted, repaired, or replaced. If the failed node has not been made operational, then the process or processes are continued on the virtual node in step 414. However, if the failed node has been repaired, replaced, or otherwise made operational, then the process or processes running on the virtual node may be moved and resumed on the original node. The method ends generally at step 418.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A method of failover in a cluster having one or more cluster nodes, comprising:
providing a second server operative with said cluster;
detecting a failed process on one of said cluster nodes; and
duplicating said process on a virtual node on said second server;
wherein said process is resumed on said virtual node.

2. The method of claim 1, wherein said second server is a failover server.

3. The method of claim 1, wherein said second server is a backup server.

4. A system comprising:
a cluster, said cluster composed of one or more cluster nodes, each of said cluster nodes constructed and arranged to execute at least one process; and
a second server, said second server operative with said cluster, said second server having one or more virtual nodes, each of said virtual nodes being constructed and arranged to execute said process of said one or more cluster nodes;
wherein if one or more of said cluster nodes fails, then said process of said failed cluster node is transferred to one of said virtual nodes of said second server.

5. The system of claim 4, wherein said second server is a failover server.

6. The system of claim 4, wherein said second server is a backup server.

7. The system of claim 4 further comprising a third server, said third server operative with said second server, said third server having one or more virtual nodes, each of said virtual nodes being constructed and arranged to execute the instructions of one or more virtual nodes of said second server.

8. The system of claim 7, wherein said second server is a failover server and said third server is a backup server.

9. A system comprising:
a cluster, said cluster composed of one or more cluster nodes, each of said cluster nodes constructed and arranged to execute one or more processes;
a distributed cluster manager operative with each of said cluster nodes, said distributed cluster manager constructed and arranged to detect failure of said one or more processes on said one or more cluster nodes; and
a second server, said second server operative with said distributed cluster manager, said second server having a dynamic virtual failover layer operative with said distributed cluster manager, said second server further having one or more virtual nodes operative with said dynamic virtual failover layer, each of said virtual nodes being constructed and arranged to execute said one or more processes of said one or more cluster nodes;
wherein if one or more of said cluster nodes fails, then said one or more processes of said failed cluster node are transferred to one of said virtual nodes of said second server.

10. The system of claim 9 further comprising:
a third server, said third server operative with said distributed cluster manager, said third server having a dynamic virtual failover layer operative with said distributed cluster manager, said third server further having one or more virtual nodes operative with said dynamic virtual failover layer of said third server, each of said virtual nodes of said third server being constructed and arranged to execute said one or more processes of said one or more cluster nodes.

11. The system of claim 9, wherein said second server is a failover server.

12. The system of claim 10, wherein said second server is a failover server.

13. The system of claim 10, wherein said third server is a backup server.

14. An apparatus composed of one or more cluster nodes having at least one computer, said computer having at least one microprocessor and memory capable of executing one or more processes, said apparatus further comprising:
a second server, said second server operative with said cluster, said second server having one or more virtual nodes, each of said virtual nodes being constructed and arranged to execute said process of said one or more cluster nodes;
wherein if one or more of said cluster nodes fails, then said process of said failed cluster node is transferred to one of said virtual nodes of said second server.

15. The apparatus of claim 14, wherein said second server is a failover server.

16. The apparatus of claim 14, wherein said second server is a backup server.

17. The apparatus of claim 14 further comprising a third server, said third server operative with said second server, said third server having one or more virtual nodes, each of said virtual nodes being constructed and arranged to execute the instructions of one or more virtual nodes of said second server.

18. The apparatus of claim 17, wherein said second server is a failover server and said third server is a backup server.

19. An apparatus having a cluster, said cluster composed of one or more cluster nodes, each of said cluster nodes having one or more microprocessors and memory, said nodes constructed and arranged to execute one or more processes, said apparatus further comprising:
a distributed cluster manager operative with each of said cluster nodes, said distributed cluster manager constructed and arranged to detect failure of said one or more processes on said one or more cluster nodes; and
a second server, said second server operative with said distributed cluster manager, said second server having a dynamic virtual failover layer operative with said distributed cluster manager, said second server further having one or more virtual nodes operative with said dynamic virtual failover layer, each of said virtual nodes being constructed and arranged to execute said one or more processes of said one or more cluster nodes;
wherein if one or more of said cluster nodes fails, then said one or more processes of said failed cluster node are transferred to one of said virtual nodes of said second server.

20. The apparatus of claim 19 further comprising:
a third server, said third server operative with said distributed cluster manager, said third server having a dynamic virtual failover layer operative with said distributed cluster manager, said third server further having one or more virtual nodes operative with said dynamic virtual failover layer of said third server, each of said virtual nodes of said third server being constructed and arranged to execute said one or more processes of said one or more cluster nodes.

21. The apparatus of claim 19, wherein said second server is a failover server.

22. The apparatus of claim 20, wherein said second server is a failover server.

23. The apparatus of claim 20, wherein said third server is a backup server.
